(19) United States
(12) Patent Application Publication
(10) Pub. No.: US 2022/0386734 A1
(43) Pub. Date: Dec. 8, 2022

(54) ADJUSTABLE LOOPED-CORD GOGGLE ATTACHABLE TO A HELMET

(71) Applicant: Jordan Hunter, Tempe, AZ (US)

(72) Inventor: Jordan Hunter, Tempe, AZ (US)

(21) Appl. No.: 17/339,659

(22) Filed: Jun. 4, 2021

(51) Int. Cl. A42B 3/18; G02C 3/00; G02C 3/02; G02C 5/00

(52) U.S. Cl. CPC A42B 3/185; G02C 3/003; G02C 3/02; G02C 5/001

(57) ABSTRACT

An adjustable looped-cord goggle attachable to a helmet is provided. The goggle includes a goggle frame having a first side and a second side, one or more channels formed along an internal periphery of frame, and an elastic cord adapted to form a first loop and a second loop. A first end of the cord fastened to a first position on the first side of the frame and a second end exits through a second position on the first side of the frame forming the first loop. A remaining portion of cord is passed through the channels to reach the second side of the frame. Further, the second end of the cord is passed through a third position and exits at a fourth position on the second side of the frame forming the second loop. The first loop and second loop fasten the goggle frame to the helmet.

### TECHNICAL FIELD

The present disclosure relates generally to an adjustable looped-cord goggle which is attachable to a helmet.

### BACKGROUND

Goggles are worn in many sports for various reasons. For instance, in mountain biking, goggles are worn to protect the rider's eyes from wind and flying objects such as dirt, dust, rocks, insects, and other debris. Goggles are often worn together with a helmet. Helmets reduce the chances of serious injury during a fall or crash.

Typically, goggles are held on the user's head or helmet by the use of one or more straps. However, sometimes the rider will want to remove or adjust their goggles. For instance, in an enduro mountain bike race where only downhills are timed, the rider may wish to remove his or her goggle during the uphill portions of the race. Conventional goggles are not designed for a convenient way to adjust the goggles or switch the goggles to a different position, and may have to be removed altogether.

### SUMMARY

An adjustable looped-cord goggle attachable to a helmet is disclosed. The goggle comprises a goggle frame having a first side and a second side, one or more channels formed along a periphery of the frame, and a single, continuous cord, portions of which form a pair of external loops. The cord has a first end and a second end. The first end of the cord is fastened to a first position on the first side of the frame and a second end exits through a second position on the first side of the frame forming the first loop. A remaining portion of the cord adapted to pass through the channels to reach the second side of the frame. The second end of the cord is passed through a third position on the second side frame and exits at a fourth position on the second side of the frame forming the second loop. Further, a pair of goggle attachment devices are detachably attached to both left and right sides of the helmet to receive the first and second loop, respectively. The first loop and second loop engage the respective cord holder elements to fasten the goggle frame to the helmet. In one embodiment, either of the first end and second end could be pulled downwards or upwards to adjust tightness of the loop before fastening the ends of cord.

In an embodiment, the frame has a substantially rectangular shape. In an embodiment, the first position and the second position define two opposing edges of the first side of the helmet. In an embodiment, the third position and the fourth define two opposing edges of the second side of the helmet. The edges include one or more apertures adapted to allow passage of the cord. In an embodiment, the cord holder element comprises a rounded head, an adhesive base and an elongate portion extending between the head and base. Each loop adapted to hook around the elongate portion of the cord holder element and the rounded head adapted to prevent disengagement of the loop.

In an embodiment, a method of forming the goggle is disclosed. In one step, a goggle frame having one or more channels formed along an internal front periphery of the frame is provided. The frame having a first side and a second side. In another step, at least one cord having a predefined length sufficient form a first loop and a second loop is provided. The formation of the first loop involves a step of fastening a first end to a first position on the first side of the frame, leaving a length of cord to form the first loop, and passing a second end of the cord through a second position on the first side of the frame to form the first loop. The formation of second loop involves a step of passing a remaining portion of cord through the channels to reach the second side of the frame, passing the second end of the cord through a third position on the second side of the frame, leaving a length of cord to form the second loop before fastening the second end at a fourth position at the second side of the frame.

### BRIEF DESCRIPTION OF THE DRAWINGS

FIG. 1 exemplarily illustrates a perspective side view of a goggle attached to a helmet by incorporation of a goggle attachment device, according to an embodiment of the present invention.

FIG. 2 exemplarily illustrates a perspective side view of the goggle.

FIG. 3 exemplarily illustrates a cutaway front view of the goggle.

FIG. 4A through FIG. 4F exemplarily illustrate a technique for attachment of the goggle to the helmet, according to an embodiment.

FIG. 5 exemplarily illustrates the goggle positioned over a forehead region of the helmet.

FIG. 6 exemplarily illustrates the goggle positioned over a top region of the helmet.

FIG. 7 exemplarily illustrates the goggle positioned over a rear head region of the helmet.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

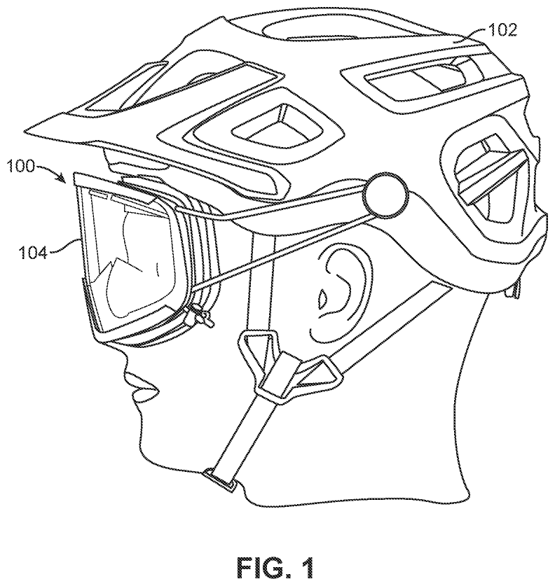

FIG. 1 illustrates a perspective side view of a goggle 104 attached to a helmet 102 by incorporation of goggle attachment devices 112 (only one of which is shown in this view), according to an embodiment. As will be described in greater detail, this arrangement (hereinafter referred to as goggle system 100) allows a wearer to readily attach or detach the goggle 104 to the helmet 102. Additionally, it further allows the wearer to readily change the position of the goggle 104 from the wearer's face to over the helmet 102 when the goggle 104 is not needed. The goggle system 100 includes an economical attachment mechanism that allows the wearer to change the position of the goggle 104 with one hand, which includes adjustment of the goggle 104 over the wearer's eyes, positioning of goggle 104 over the helmet 102, or removing the goggle 104 from the helmet 102. It is to be appreciated that the ornamental design of the illustrated helmet 102 is not limiting, and that various other helmets of different designs, shapes, and sizes may suffice.

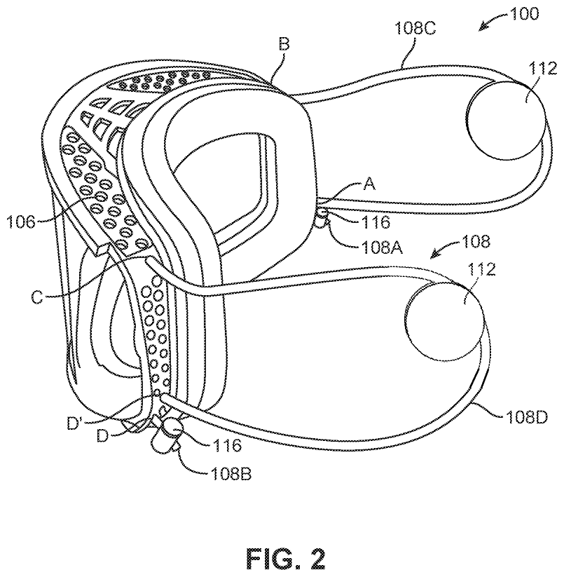

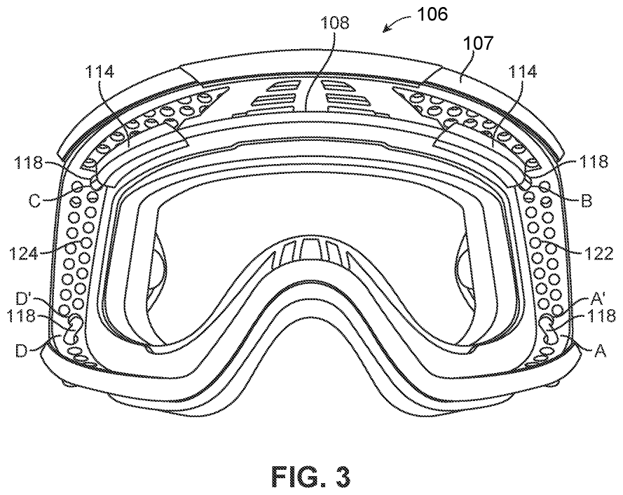

Referring to FIG. 2 and FIG. 3, a side perspective and a cutaway front view of the looped-cord goggle 104 are respectively illustrated. The goggle 104 comprises a goggle frame 106, for supporting a protective lens therewithin (which can be a single continuous piece of transparent plastic). The goggle frame 106, in accordance with one embodiment, has a substantially rectangular shape including a first side 122, a second side 124, and one or more internal channels 114, and, externally, a pair of loops 108C-108d. A single, continuous cord 108 is adapted to form the first loop 108C and the second loop 108D, to engage with the goggle attachment devices 112. Preferably, the cord 108 is elastic. Preferably the cord 108 will be capable of being stretched to at least about 150% of its non-stretched length, and then to assume its non-stretched length once it no longer is stretched. In an embodiment, the cord 108 is a shock cord. In the case of shock cord, preferably the cord 108 will be capable of being stretched from about 150% to about 200% of its non-stretched length, and then to assume its non-stretched length once it no longer is stretched.

Referring to FIG. 3, the internal channels 114 are formed along a periphery inside the goggle frame 106. In the illustrated embodiment, the channels 114 are formed at a front internal side of the frame 106 a majority portion of which follow no more than ab out an inch underneath the top bar 107 of the frame. In another embodiment, the channels 114 may be formed at a rear internal side of the frame 106.

Referring to FIGS. 2 and 3, the cord 108 has a first end 108A and a second end 108B. The first end 108A is fastened to a first position, represented as A, on the first side 122 of frame 106. A length of the cord 108 is left to form the first loop 108C. The second end 108B is passed through a second position, represented as B, on the first side 122 of the frame 106. Thereby, the first loop 108C is formed at first side 122 of the goggle frame 106. To form the second loop 108D on the second side 124 of the frame 106, a remaining portion of cord 108 is passed through the channels 114 to reach the second side 124 of the frame 106. The second end 108B of the cord 108 is passed through the second position, represented as C, on the second side 124 of the frame 106.

A length of the cord 108 is left free to form the second loop 108D and the second end 108B is passed through a fourth position, represented as D, on the second side 124 of the frame 106. The second end 108B is fastened at the fourth position to form the second loop 108D of the goggle frame 106. Here, the first position and the second position define two opposing edges of the first side 122 of the frame 106. The third position and the fourth position define two opposing edges on the second side 124 of the frame 106. The edges of frame 106 include apertures 118 to allow passage of the cord 108 to pass therethrough.

The edges of frame 106 further includes positions, represented by A′ and D′, adapted to receive respective ends (108A, 108B) to knot around, for example. This additional knot prevents loosening of the cord 108 fastened to the frame 106. In one embodiment, the ends (108A, 108B) of the cord 108 are provided with a cord lock fastener (also known as a lace lock fastener) or the like. The cord lock fastener comprises an elongate tab 116. The tab 116 is dimensioned to prevent the passage of the tab 116 through the apertures 118 whereby the ends (108A, 108B) are locked in their respective position. In an alternative embodiment, the ends (108A, 108B) are made into a knot sufficiently larger than the circumference of aperture 118 whereby the ends (108A, 108B) are fastened at their respective position.

Still referring to FIG. 2 and FIG. 3, the goggle attachment devices 112 are detachably attachable to both left and right sides of the helmet 102 to fasten the loops (108C, 108D). In one embodiment, the goggle attachment devices 112 each comprise an adhesive base, an elongate portion extends from the base, a rounded head formed over the elongate portion. The adhesive base may include a pressure-sensitive adhesive. The diameter of the rounded head is larger than the diameter of the elongate portion. Each loop (108C, 108D) is adapted to hook around the elongate portion and the rounded head is adapted to prevent disengagement of the loop (108C, 108D) from the goggle attachment devices 112. More specifically, a groove is configured between the base and the rounded head within which the cord may be accommodated. In one embodiment, the length of the elongate portion is not more than the width of the cord 108 so as to prevent the horizontal movement of the cord 108 once hooked to the goggle attachment devices 112. In another embodiment, alternate conventional mechanisms could be used to hook the loop (108C, 108D) on either side of the helmet 102. Although the goggle attachment devices 112 are shown as substantially circular, it is to be understood that the goggle attachment devices could assume a different shape (e.g., oval, triangular, star-shaped). Furthermore, although the goggle attachment devices 112 include a groove, it is to be understood that the groove feature could be absent in some embodiments.

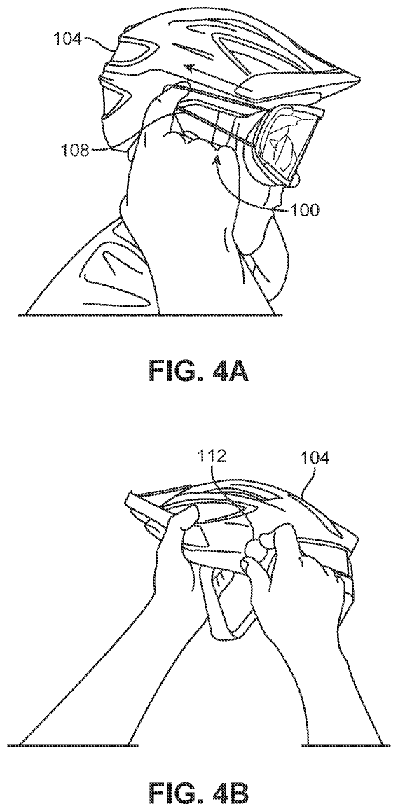

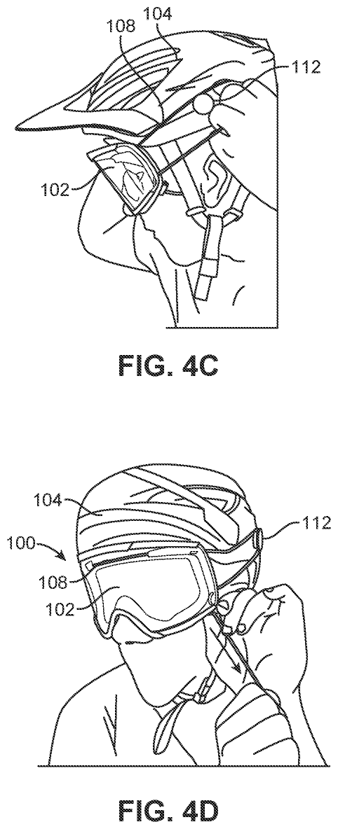

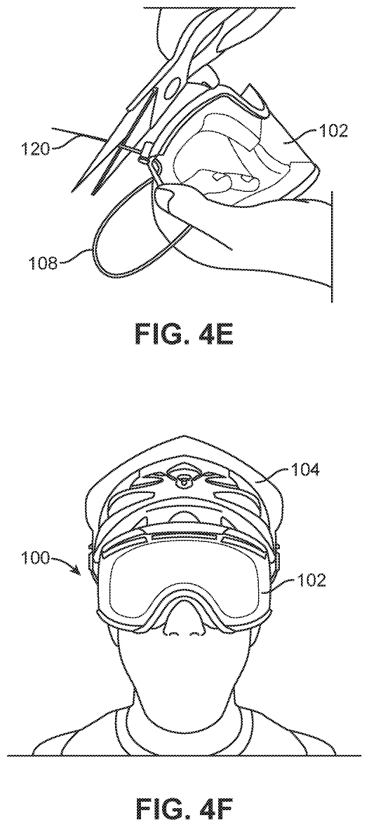

FIG. 4A through FIG. 4F exemplarily illustrate a method of attachment of the goggle 104 to the helmet 102. Referring to FIG. 4A, the user needs to wear helmet 102 and place the goggle 104 in position against the eyes. The loops (108C, 108D) at either side are pulled back until the goggle 104 is comfortably fitted across the user/wearer eyes. Thereby, a distance and position at where the loop (108C, 108D) need to be fastened is determined. Referring to FIG. 4B, the goggle attachment devices 112 are detachably attached at the determined positions of the helmet 102 using the adhesive base. Referring to FIG. 4C, the user needs to position the goggle 104 across the eyes at a comfortable position. Then the loops (108C, 108D) are pulled back and hooked around the goggle attachment devices 112. In the preferred case where the loops (108C, 108D) are elastic, stretching the loops in this manner will create sufficient tension to hold the loops (108C, 108D) to the corresponding goggle attachment devices 112 even while the user engages in a rigorous sport. Although the goggle attachment devices 112 are described as being detachably attachable to the helmet (that is, they can be removed without much effort after attachment), it is to be understood that the goggle attachment devices 112 could instead be permanently affixed onto the helmet 102. Furthermore, it is to be appreciated that the goggle attachment devices 112 may be an after-market item or sold and/or made integral with the helmet (e.g., during fabrication, assembly, or molding of the helmet 102).

Referring to FIG. 4D, if the user feels the need to adjust the fit, the user could adjust the length of the cord 108 by pulling or retracting the ends (108A, 108B) of the cord 108. After identifying the desired fit, the user could fasten the end (108A, 108B) at a desired length. Referring to FIG. 4E, excess length 120 of the cord 108 could be removed by simply cutting the length of the cord 108 that is not required. In one embodiment, the excess length 120 could be weaved at the apertures 118 of the frame 106. Referring to FIG. 4F, the user secures the goggle 104 to the helmet 102 and ready for physical activity such as mountain biking, motorcycling, horse riding, skiing, snowboarding, snowmobiling, etc.

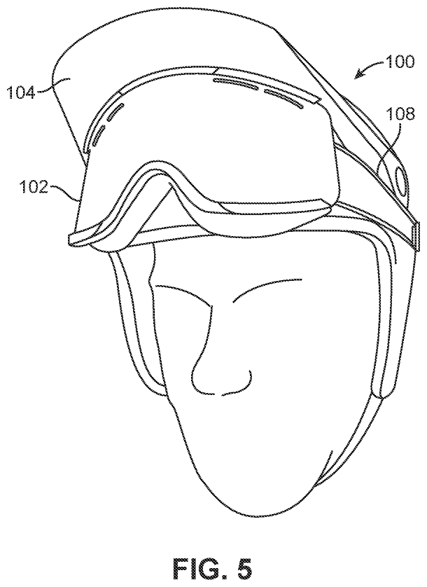

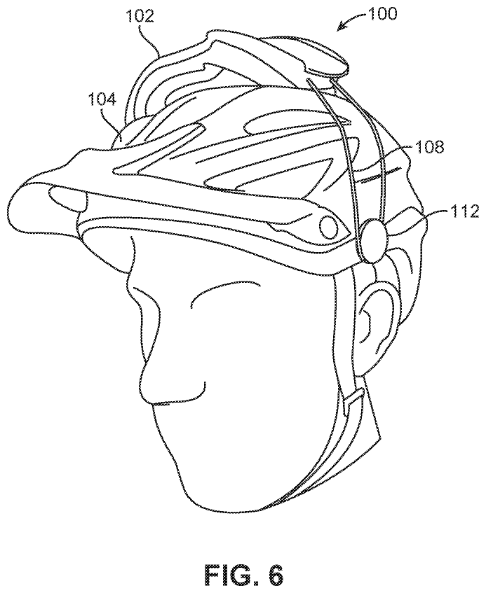

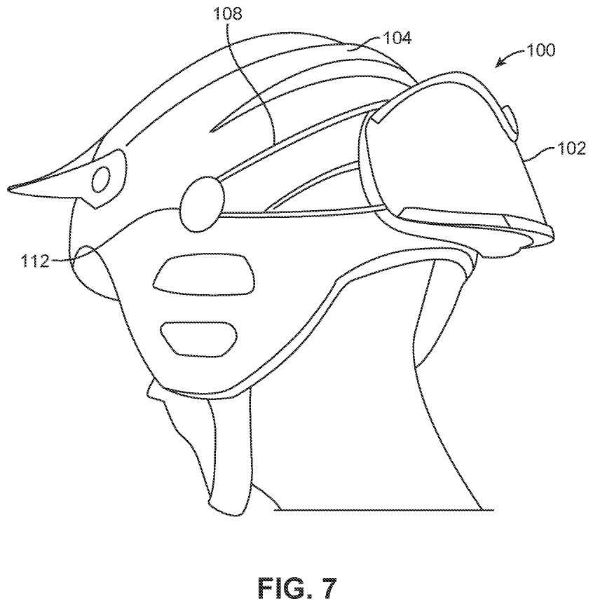

The goggle attachment devices 112 and the cord 108 allow the wearer to move the goggle 104 at any desired position as shown in FIG. 5 to FIG. 7. Referring to FIG. 5, in one example, the goggle 104 is positioned over a forehead region of the helmet 102 using the goggle attachment system 100. Referring to FIG. 6, in another example, the goggle 104 is positioned over a top region of the helmet 102 using the goggle attachment system 100. Referring to FIG. 7, in yet another example, the goggle 104 is positioned over a rear head region of the helmet 102 using the goggle attachment system 100.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A goggle system, comprising:
a goggle, including
a goggle frame having a first side and a second side;
channels formed internally within the frame, including one which follows along underneath a top bar of the frame;
a cord configured to extend through the channels and to form, externally, a first loop and a second loop, and
a pair of goggle attachment devices configured to be attached to a left and a right side of a helmet, respectively, wherein the first loop and second loop engages respective cord holder elements of the goggle attachment devices to fasten the goggle frame to the helmet.

2. The goggle system of claim 1, wherein the frame has a substantially rectangular shape.

3. The goggle system of claim 1, wherein the first position and the second position define two opposing edges of the first side of the frame.

4. The goggle system of claim 1, wherein the third position and the fourth position define two opposing edges of the second side of the frame.

5. The goggle system of claim 3, wherein the edges include a plurality of apertures adapted to allow passage of the cord.

6. The goggle system of claim 1, wherein at least one cord holder element is detachably attached to left and right sides of the helmet to receive respective first and second loops.

7. The goggle attachment system of claim 1, wherein the goggle attachment devices each comprise a rounded head, an adhesive base and an elongate portion extending between the head and base.

8. The goggle system of claim 1, wherein the first loop and the second loop are adapted to hook around respective one of the elongate portions of the goggle attachment devices and the rounded heads adapted to prevent disengagement.

9. The goggle system of claim 1, wherein the lengths of the first loop and the second loop are each adjustable by pulling the ends of the cord either upward or downward before fastening the ends of the cord.

10. The goggle system of claim 1, wherein the cord is elastic.

11. The goggle system of claim 10, wherein the cord is a shock cord.

12. The goggle system of claim 10, wherein the cord is capable of being stretched to about 150% of its non-stretched length, and then to assume its non-stretched length once it no longer is stretched.

13. The goggle system of claim 10, wherein the cord is capable of being stretched to at about 200% of its non-stretched length, and then to assume its non-stretched length once it no longer is stretched.

14. The goggle system of claim 1, wherein a first end of the cord fastened to a first position on the first side of the frame and a second end exits through a second position on the first side of the frame forming a first loop, wherein a remaining portion of cord passed through the channels to reach the second side of the frame, and the second end of the cord is passed through a third position on the second side frame and exits at a fourth position on the second side of the frame forming the second loop.

15. The goggle system of claim 1, wherein the cord is a single continuous cord.
